(19) United States
(12) Patent Application Publication
(10) Pub. No.: US 2020/0002489 A1
(43) Pub. Date: Jan. 2, 2020

(54) LOW MICROGEL SURFACE PROTECTION FILM

(71) Applicant: TREDEGAR FILM PRODUCTS CORPORATION, Richmond, VA (US)

(72) Inventors: Carl Douglas Ray, Chesterfield, VA (US); Shailesh Chunilal Patel, Chesterfield, VA (US); Bankim Bhupendra Desai, Chesterfield, VA (US); James Mason Yourshaw, Orwigsburg, PA (US)

(21) Appl. No.: 16/545,780

(22) Filed: Aug. 20, 2019

Related U.S. Application Data
(62) Division of application No. 15/172,660, filed on Jun. 3, 2016, now abandoned.
(60) Provisional application No. 62/171,473, filed on Jun. 5, 2015.

(51) Int. Cl. C08J 5/18; B29B 13/02; B29C 48/08

(52) U.S. Cl. CPC C08J 5/18; B29B 13/022; B29L 2007/00; B29K 2023/06; B29C 48/08

(57) ABSTRACT

A method of forming a thermoplastic polymer film includes melting and subjecting a polymer resin material to shear stresses in a range of 250 kPa to 400 kPa to form a refined resin material and forming the thermoplastic polymer film from the refined resin material. The film is substantially free of microgels having a largest dimension greater than 50 microns. The film has a thickness in a range of 15 micron to 80 microns. The film has a microgel count in a range of 0 to 0.2 per mm² of microgels having the maximum dimension greater than 10 microns.

### CROSS-REFERENCE TO RELATED APPLICATIONS

This United States Patent Application is a continuation of U.S. patent application Ser. No. 15/172,660, filed on Jun. 3, 2016, which relies on and claims priority to U.S. Provisional Application No. 62/171,473, filed on Jun. 5, 2015, the complete disclosures of both of which are incorporated herein by reference in their entireties.

### FIELD OF THE INVENTION

The invention relates generally to polymer film materials and, more particularly, to polymer surface protection films and methods of forming such films that reduce the size, protrusion and number of included gels and microgels.

### BACKGROUND OF THE INVENTION

Surface protection films, also known as masking films, liners, or interleaf films, are typically used to provide a physical barrier to prevent damage, contamination, scratching, scuffing, or other marring of a substrate. Surface protection films are also interchangeably used as interleaf films to prevent interlayer sticking or blocking of soft and fragile optical films for the purpose of light management in display industry. Masking films may be used to provide such protection during manufacture, shipping, or storing prior to use of the substrate, for example. Such films may be used in numerous applications as protective coverings for surfaces, particularly for protecting relatively smooth surfaces, such as acrylics, Cyclo-Olefin Polymers (COP), PMMA, polycarbonates, glass, polished or painted metals and glazed ceramics. Optical substrates for televisions, monitors, phones, tablets, and other displays, for example, require masking films that both protect the surface and may be removed without damaging, leaving residue of an adhesive, or other contaminants or particulates on the surface.

Many optical substrates are also susceptible to damage due to irregularities in the topography of the contact surface of the masking film itself. While generally planar, the contact surface of any masking film will have some irregularity in the form of concave areas (pits) and convex areas (protrusions). Protrusions are of particular concern because they can cause corresponding transcriptions (indentations) in the substrate to which the masking film is applied.

Until recently, most optical substrates could tolerate small imperfections in the masking film contact surface. Now, however, the development of substrate materials for high resolution applications has resulted in more stringent quality requirements. Protrusions of even one or two microns can unacceptably damage the surface of these materials. In addition, these substrates require high resolution optical inspection, which must be accomplished with the masking film in place. This means that the masking film must not only be light transmittent, it must exhibit a very high degree of transparency and clarity for visual inspection. Materials previously considered “low haze” have insufficient clarity to allow such inspection, although in some case, it may be possible to detect and characterize defects through higher haze surface protection films by using an improved in-line camera system.

These more stringent requirements have resulted in the virtual elimination of the use of certain polymer materials as masking films for high resolution optical substrates. This is because films formed from such materials (e.g., polyolefins, generally and polyethylene (PE), tend to include small polymer agglomerations typically referred to as “gels” or “fish-eyes” that are not removed during, and in some cases may even be caused by, the extrusion process. Gels may include, for example, unmelted polymer entanglements, unmelted/undispersed polymer, or crosslinked chains formed by oxidation. The presence of such gels—even those smaller than 100 μm (referred to herein as “microgels” and which are sometimes referred to as “micro-fisheyes”)—within a thin polymer film can result in bulges at the film surface as illustrated in FIGS. 1 and 2. These bulges can be measured by their plan-form area as viewed normal to the surface and by a protrusion height hp measured from the generally planar surface of the film.

Heretofore, only certain, relatively expensive, polymers such as polyesters have been usable to manufacture films that meet the stringent requirements for protecting today's high definition optical substrates. It is highly desirable to provide surface protection films formed from more cost-effective polymers such as PE and other polyolefins, but that provide performance attributes equivalent to that of adhesive coated PET masking films.

### SUMMARY OF THE INVENTION

An aspect of the invention provides a method of forming a thermoplastic polymer film. The method includes melting and subjecting a polymer resin material to shear stresses in a range of 250 kPa to 400 kPa to form a refined resin material and forming the thermoplastic polymer film from the refined resin material. The film is substantially free of microgels having a largest dimension greater than 50 microns. The film has a thickness in a range of 15 micron to 80 microns. The film has a microgel count in a range of 0 to 0.2 per mm² of microgels having the maximum dimension greater than 10 microns.

In the method, the polymer resin material may consist primarily of one or more polyolefins. For example, the polymer resin material may consist primarily of polyethylene.

The method also may include mixing the polymer resin material with one or more antioxidants.

Still further, the method may be executed where the polymer resin material is subjected to shear stresses in a range of 300 kPa to 375 kPa to form the refined resin material.

In another embodiment, it is contemplated that the method includes extruding and solidifying the refined resin material.

It is also contemplated that, where the polymer resin material includes at least a majority by weight of polyethylene, the method also may include mixing the polymer resin material with one or more antioxidants and extruding and solidifying the refined resin material.

The present invention also provides a method of forming a polymer film. The method includes providing a polymer resin material consisting primarily of polyethylene, mixing the polymer resin material with one or more antioxidants to form a resin material mixture, melting and subjecting the resin material mixture to shear stresses in a range of 250 kPa to 400 kPa to form a refined resin material, and extruding the refined resin material to form the polymer film. The polymer film is substantially free of microgels having a largest dimension greater than 50 microns. The polymer film has a thickness in a range of 15 micron to 80 microns. The polymer film has a microgel count in a range of 0 to 0.2 per mm² of microgels having the maximum dimension greater than 10 microns.

This method also may include, prior to the action of extruding the refined resin material to form the polymer film, extruding and solidifying the refined resin material and melting and subjecting the extruded and solidified refined resin material to shear stresses less than 70 kPa.

It is contemplated that extruded and solidified refined resin material may be in the form of extruded pellets.

In one contemplated variation, the resin material is subjected to shear stresses in a range of 300 kPa to 375 kPa to form the refined resin material.

Still other features of the present invention will be made apparent in the paragraph that follow.

### BRIEF DESCRIPTION OF THE DRAWINGS

FIG. 1 is a depiction of a film cross-section illustrating the effect of microgel size and location on surface topography;

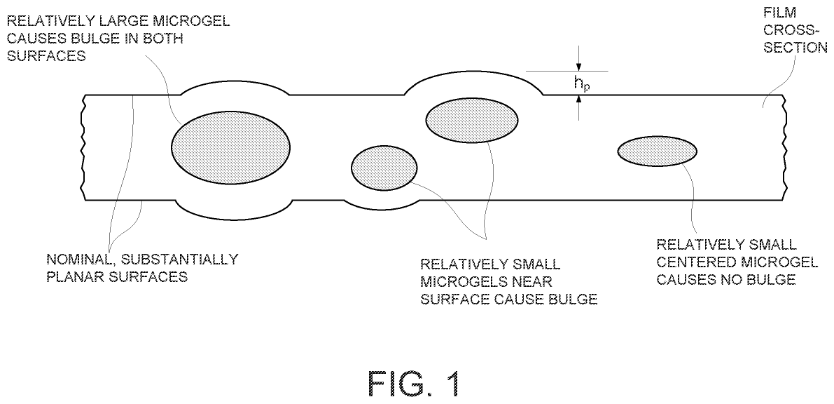

FIG. 2 is a photograph showing a surface protrusion at the surface of a polymer film having an included microgel embedded therein;

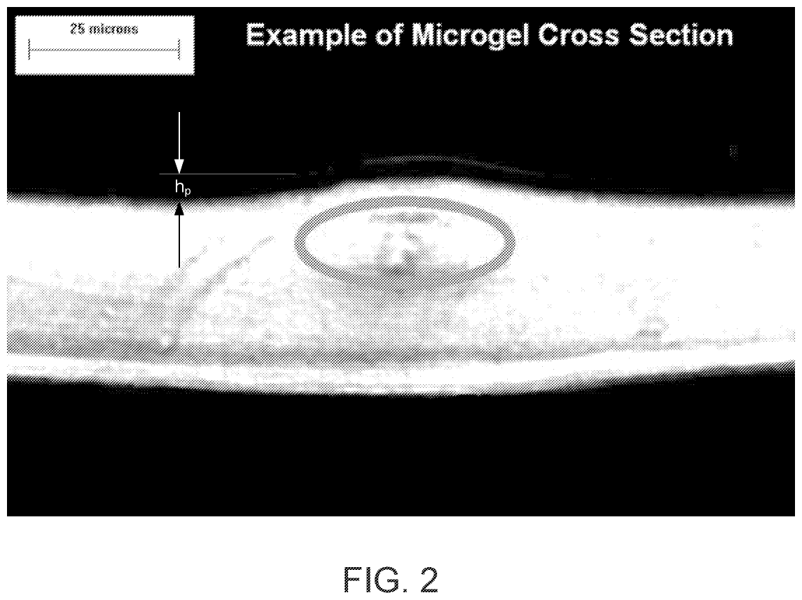

FIG. 3 is a schematic representation of an extruded film manufacturing line that can be used in methods according to the invention;

FIG. 4 is a block flow diagram of a method according to an embodiment of the invention;

FIG. 5 is a schematic representation of a high shear stress extrusion apparatus that may be used to carry out methods according to some embodiments of the invention;

FIG. 6 is a block flow diagram of a method according to an embodiment of the invention;

FIG. 7 is a depiction of a polymer film sample map with an enlarged photograph of a portion of the sample; and

FIG. 8 is a screen shot of a photograph of a film material with microgel measurements superimposed thereon.

### DETAILED DESCRIPTION OF THE INVENTION

The following description is intended to convey a thorough understanding of the various embodiments of the invention by providing a number of specific embodiments and details involving the refinement of polymer resin materials and the production of polymer film materials therefrom. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments.

The present invention provides methods for producing low microgel surface protection films from polymers such as polyolefins that typically exhibit a tendency to form and retain gel inclusions. The methods of the invention generally involve subjecting the polymer resin to very high shear stress during melting either during the process of extruding the surface protection film or as part of a preprocessing step. As will be discussed in more detail hereafter, high shear stress processing can be used to break up and melt previously unmelted or entangled gels and microgels in the base polymer resin material, but, absent additional measures, results in the formation of crosslinked gels and unmelted or entangled microgels in the extruded material. In the method of the invention, one or more measures may be used to counter the formation of crosslink gels. Thus, the resulting extrudate has no macrogels (gels having a longest dimension greater than 100 microns) and has significantly fewer and smaller microgels than the base resin and an extrudate formed from the same polymer using a standard extrusion process.

As used herein “film” refers to sheets or membranes having a thickness less than 1000 microns. Surface protection films typically have thicknesses less than 100 microns and may have thicknesses well below 50 microns. In such films, any microgel greater than 10-20 microns may significantly distort the substantially planar surface of the film. It will be understood that the term “substantially planar” in regard to a film surface is intended to refer to the nominally regular surface that would be planar if the pliable film were applied to a flat surface.

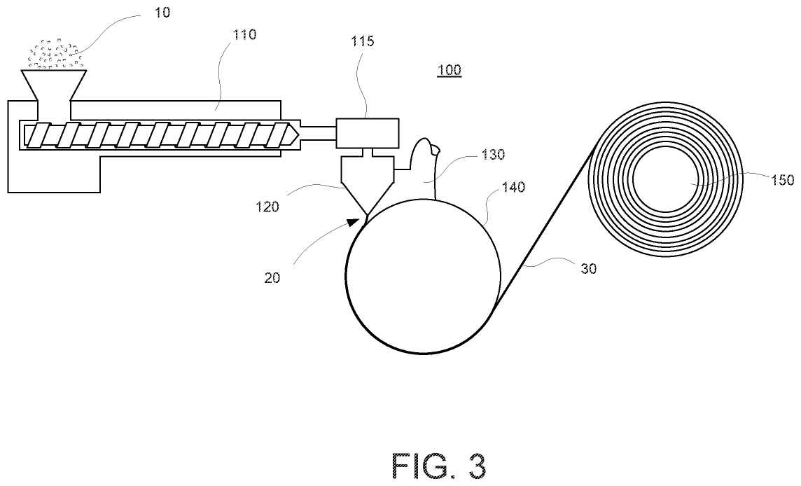

The difficulties presented by the occurrence of gels and microgels in polymer films produced using standard techniques is well-known. In a typical extruded film production line 100 such as that depicted schematically in FIG. 3, polymer resin material 10, typically in pellet form or a combination of pellets and recycled fluff from edge trimmings, is fed into a conventional extruder 110 to melt and extrude the resin material 10 via a die 120 as a web 20. For cast webs, a traditional slot die is used. For blown webs a circular or elliptical die may be used. In some embodiments (e.g., a no side matte (NSM) process), the web 20 of extruded resin material may be drawn onto a casting roll 140 through the use of a vacuum box 130. In other embodiments (e.g., a one side matte (OSM) process), vacuum assistance may not be required to cast the material. It will be understood that although a vacuum box 130 is illustrated and described herein, any suitable means applying negative pressure can be used. The casting roll will typically be smooth so as to impart a smooth, substantially planar surface to the resulting cast film 30. In some embodiments, however, one or both surfaces of the cast film may be provided with a textured or patterned surface. The cast film 30 may undergo additional processing to impart a particular texture or pattern to the surface opposite the smooth surface. This could include for example, heating the cast film 30 and then drawing it between a smooth roll and a rubber or other textured roll (not shown). The film 30 may also be trimmed to a predetermined width. The resultant film is wound onto roll 150 for storage and/or transportation or further processing prior to use.

The exemplary extrusion process of FIG. 3 shows the formation of a single layer film. It will be understood that a multiple layer film may be produced by providing for multiple extruders, each forming a single layer as depicted in FIG. 3 or, alternatively, splitting the output of a single extruder into multiple layers using a coextrusion feed block. In either case, the multiple layers are collectively cast onto the casting roll to form a single laminate film. The various layers may be formed from the same or different materials. Some films, for example, may be formed with three layers: a core layer bounded by an adhesion layer configured for contacting a substrate and a release layer. In short, extruded protection layer polymer films can have any number of layers of varying or similar materials.

A PE film produced using the above process will meet the requirements of many applications, but the presence of microgel-caused surface irregularities may preclude it for many surface protection film applications. While there are many types of gels that can cause such irregularities (see Spalding et al., “Troubleshooting and Mitigating Gels in Polyolefin Film Products,” Plastics Engineering September 2013, pp. 50-58. (“Spalding Paper”)), the methods of the present application are primarily directed to control of those that are (1) entangled undispersed polymer chains that remain unmelted during the extrusion process or that have solidified before ejection from the extruder die (“unmelt gels” or “unmelt microgels”) or (2) crosslinked due to oxidation or shear induction (“crosslink gels” or “crosslink microgels”).

Gels of both types (and others) may be present in the base resin provided by the resin manufacturer. The basic extrusion process described above will generally remove the larger gels, but is ineffective in removing the smaller unmelt gels, particularly unmelt microgels. It has been suggested that unmelt micro gels can be removed from PE film materials by using relatively high (100-200 kPa) shear stress levels. See Spalding Paper. While Spalding suggests that such shear stress level are attainable using a conventional single screw extruder with a Maddock-type mixer, the inventors have found that such extruders are generally limited to a maximum shear stress in the range of 60-70 kPa, which has been demonstrated to be insufficient to reduce the microgel defects of concern.

Not only is the maximum shear stress available in a single screw extruder insufficient, the inventors have found that even the relatively high shear stress levels suggested by Spalding are insufficient to reduce microgels to a size that does not cause unacceptable surface protrusions in the final PE film. Only through the use of extremely high shear stress in a twin screw extruder was it possible to break down the unmelt microgels to a sufficient degree. Absent other measures, however, it was found that the high temperature, high shear stress process resulted in a large number of crosslink gels.

The methods of the present invention overcome the problems described above. In an illustrative embodiment, the invention provides a method of refining and/or homogenizing a polymer resin alone or in combination with other film product constituents. In a particular variation of this embodiment, the resin refinement and/or homogenization process is used as a preprocess step in a process for extruding polymer films having only microgels below desired size or numbers criteria. In another illustrative embodiment, the invention provides a continuous film manufacturing process that includes actions for refining and/or homogenizing the base resin.

The methods of the present invention are usable to produce polyolefin films that are substantially free of microgels having a maximum dimension greater than 100 microns. In particular embodiments, the methods of the invention may be used to produce polyolefin films in which the largest maximum dimension of any observed microgel is in a range of 10 microns to 60 microns. In some particularly significant embodiments, the methods of the invention may be used to produce polyolefin films in which the largest maximum dimension of any observed microgel is in a range of 20 microns to 50 microns. The methods of the invention are also usable to produce polyolefin films with a microgel count (number of microgels over 10 microns in size) less than 0.1 per mm². Further, they are usable to produce polyolefin films that exhibit no protrusions that extend more than 1.0 micron from a nominal planar surface of the film.

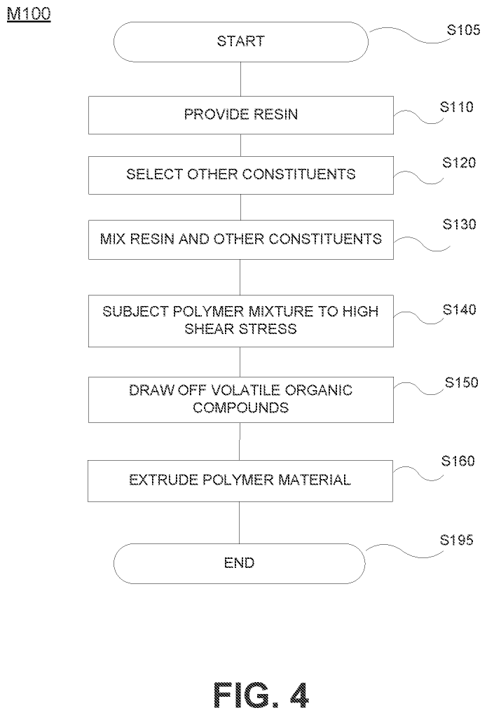

With reference to FIG. 4, a generalized method M100 for producing a refined resin according to an embodiment of the invention begins at S105. At S110, the resin material is provided and/or received from the resin manufacturer. The method M100 may be practiced with any thermoplastic resin material, but, as discussed above, is primarily aimed at resin materials having unmelt gels and microgels. Resin material is typically provided in the form of pellets that can be premixed or compounded with other constituents. At S120, other constituent materials are selected. These materials may include, in particular, stabilizing materials selected specifically to counter observed crosslinking effects encountered during very high shear stress extrusion.

As noted above, it has been found that very high shear stress (greater than 250 kPa) extrusion processes tend to result in a high degree of crosslinking in the extruded resin. Such crosslinking can be attributed to both the high shear stress level itself and to the resulting high temperatures encountered in the extruder. It is thought that the high shear stress environment creates a high number of free radicals available to crosslink the polymer chains in the melt. High heat, long residence time and the presence of oxygen increases the tendency for oxidation and further crosslinking.

To counter these effects, one or more stabilizing materials can be added to the resin. The specific stabilizers (e.g., antioxidant stabilizers) selected may depend on, without limitation, the primary polymer, the particular resin formulation, the level of shear stress to be used, temperature control measures, and other factors.

The role of antioxidant stabilizers in thermopolymers such as polyethylene is to protect the polymer from oxidative degradation. The mechanism for such degradation is an autocatalyzed, free radical chain process. During this process, hydroperoxides are formed which decompose into radicals and accelerate the degradation. Antioxidants prevent this degradation by (1) scavenging radicals to interrupt the oxidative chain reaction resulting from hydroperoxide decomposition and (2) consuming hydroperoxides.

In exemplary embodiments of the method such as might be used to refine PE and other polyolefin resins, the additional constituents may include a primary antioxidant configured or selected to counter thermal-related crosslinking and a secondary antioxidant configured or selected to take up shear-induced free radicals. Antioxidants contain one or more reactive hydrogen atoms which tie up free radicals, particularly peroxy radicals, forming a polymeric hydroperoxide group and relatively stable antioxidant species. Phenolic antioxidants are the largest selling antioxidant used in plastics today. They include simple phenols, bisphenols, thiobisphenols and polyphenols. Hindered phenols such as BASF's Irganox® 1076, 1010 and Ethyl 330 fulfill the radical scavenging requirement and are considered primary antioxidants. Other primary antioxidants include those listed in Table I.

TABLE I
PRIMARY ANTIOXIDANTS

2,6-Bis(1-methylheptadecyl)-p-cresol butylated hydroxyanisold BHA,
(CH₃)₃ CC₆ H₃ OH(OCH₃)
Butylated hydroxytoluene BHT, DBPC, Di-t-butyl-p-cresol
Butylated octylated phenol
4,4′-Butylidenebis(6-t-butyl-m-cresol) Santowhite powder
2,6-Di-t-butyl methylamino-p-cresol
Hexamethylenebis(3,5-di-t-butyl hydroxy-cinnamate) Irganox ®259
2,2′-Methylenebis(4-methyl-6-t-butyl phenol) CAO 5, Bis(2-Hydroxy-3-
t-butyl-5-methyl phenyl)methane, Cyanox 2246
Octadecyl 3,5-di-t-butyl-4-hydroxyhydrocinnamate Irganox ®1076
Tetrakis (methylene (3,5-di-t-butyl-4-hydroxyhydrocinnamate)methane
Irganox ®1010
4,4′-Thiobis (6-t-butyl-m-cresol) Santonox
Thiodiethylenebis(3,5-di-t-butyl-4-hydroxy)hydrocinnamate
Irganox ®1035
1,3,5-Tris(4-t-butyl-3-hydroxy-2,6-dimethylbenzyl)1,3,5-triazine-2,4,6-
(1H,3H,5H) trione Cyanox 1790
Tris(2-methyl-4-hydroxy-5-t-butylphenyl)-butane Topanol CA

A major group of antioxidants usable as secondary antioxidants include phosphorus-based antioxidants (generally phosphites). Phosphites act by converting hydroperoxides to non-chain propagating alcohols, while the phosphites themselves are oxidized to phosphates. Trisnonylphenyl phosphite is one widely used phosphite. Typical specific secondary antioxidants are GE's Weston TNPP, BASF's Ultranox 626 and Irgafos® 168. Other illustrative secondary antioxidants are listed in Table II.

TABLE II
SECONDARY ANTIOXIDANTS

Tetrakis(2,4-di-t-butyl)phenyl-(1,1-bi-phenyl)-4,4′-
diylbisphosphite Sandostab P-EPQ
Triisodecyl phosphite Weston TDP
Triisooctyl phosphite Weston TIOP
TriLauryl phosphite Weston TLP
Trisnonylphenyl phosphite
Didecyl phosphite
Di Lauryl phosphite (C₁₂ H₂₉ O)₂ PHO
Trisnonylphenyl phosphite/formaldehyde polymer Wytox 438
WytoX 320 (alkylryl phosphite)

Some or all of the antioxidants usable to counter crosslinking effects may have undesired effects if used in excess. Such effects may include, for example, migration and blooming. Accordingly, it is typically desirable to select the minimum amounts necessary to counter the crosslinking in the extruded resin. Empirical data can be used to optimize the relative amounts of the primary and secondary antioxidants for a particular resin or end use application of an extrudate.

Returning to FIG. 4, at S130, stabilizing materials and any other constituents are mixed with the base resin material. This may be accomplished in a separate mixing or compounding operation or may be accomplished by combining the materials in the hopper of a high shear stress compounding/extruding apparatus. At S140 the polymer mixture or compound is melted and sheared under shear stresses in excess of 250 kPa. In typical embodiments, the shear stress will be in a range of 250 kPa to 400 kPa. This will typically be accomplished using a high shear stress multi-screw extruder, but any device capable of imparting such shear stresses can be used. The particular shear stress used in the method M100 may be selected based on the polymer and the criteria for acceptable microgel content. As an example, for a PE resin material in which the desired maximum microgel size is about 50 microns and a median microgel size is less than 20 microns, a shear stress in excess of 300 kPa is required. In general, polyolefin materials may require a shear stress may in a range of 300 kPa to 375 kPa.

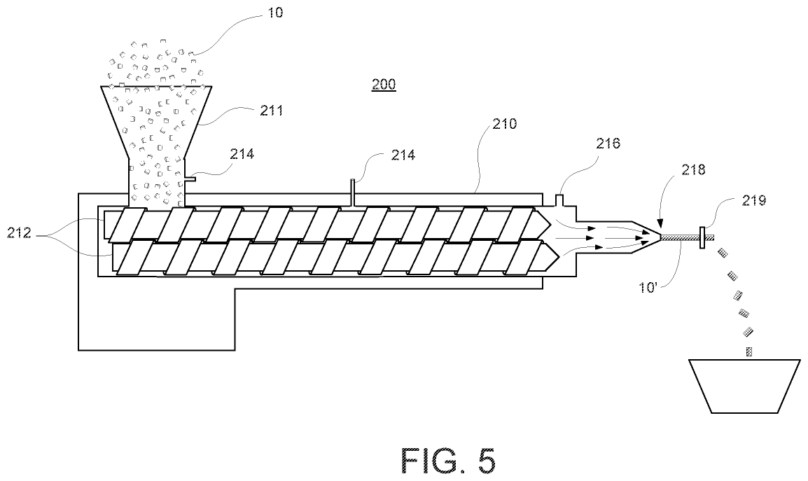

To further exemplify the invention, the action S140 of method M100 can be carried out using a twin screw extruder such as the extruder 200 shown schematically in FIG. 5. The extruder 200 includes a hopper 211 in which a polymer resin mixture 10 can be introduced into the extruder barrel 210. In some embodiments, the hopper 211 and the extruder barrel 210 may include ports 214 through which nitrogen may be introduced to displace oxygen, thereby assisting in the mitigation of oxidation in the melt. The use of a nitrogen blanket inside the extruder can assist in reducing thermal-related crosslinking in the melt. The resin 10 is then augured through the barrel 210 by twin screws 212, which impart the required high shear stress levels. The melted polymer material is then passed to a die exit 218 where it is extruded as a refined polymer extrudate 10′. In the illustrated embodiment, the refined polymer material 10′ is extruded as a rod that can be cut into pellets using any suitable cutting device 219. These pellets can then be packaged and transferred for further processing and/or use as the base material in a standard extrusion manufacturing line. As discussed below, the extruder 200 can alternatively be used in a continuous processing line for producing a final application material.

Returning once again to FIG. 4, the method M100 may include the action of drawing off volatile organic compounds (VOCs) that may occur as a result of stabilizer reactions in the melt and exposure to high stress levels. In the exemplary extruder 200 of FIG. 5, this could be accomplished by applying a vacuum line to one or more ports 216 near the end of the extruder barrel 210. At S160, the refined polymer material is extruded. In some embodiments, the extrudate may take the form of a solidified polymer rod that can be cut into pellets, which may be substantially similar in dimension to base resin pellets provided by the resin manufacturer. The method ends at S195.

The extruded polymer resulting from the above process is a refined form of the original base polymer. If sufficient shear stress is applied, the process will have removed all unmelt macrogels and significantly reduced the size of any remaining microgels without significant production of crosslink gels.

The refined polymer output of the method M100 may be nothing more than the base polymer material, any stabilizers used to mitigate crosslink gels, and any reactants stemming therefrom. This refined material may then be used in place of the base resin in a conventional extrusion process. In such cases, the refined resin material may be mixed or compounded with any other final material constituents in the conventional extruder or as part of a premixing step prior to introduction into the conventional extruder. Alternatively, any such final material constituents may be mixed or compounded with the base resin as part of action 5120 in the method M100 above.

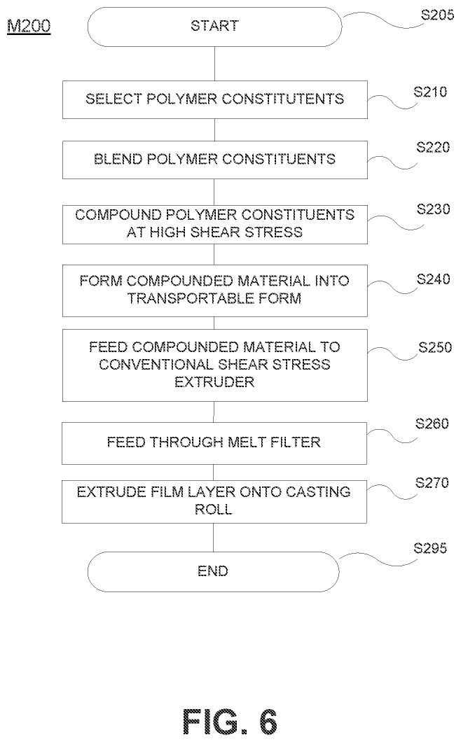

Refined resin pellets produced using the high shear stress refinement process M100 have been used as input material to a film manufacturing line similar to extruded film production line 100 of FIG. 3. With reference to FIG. 6, a method M200 of forming a polymer film in this manner begins at S205. At S210, the polymer and any other constituents for the final film material are selected. The constituent materials may include, in particular, stabilizing materials selected as previously described to counter crosslinking effects. At S220, the various polymer constituents are blended together. It will be understood that some or all of the constituents may be blended prior to high shear stress compounding. In some cases, however, certain final material constituents may be blended with the refined polymer output of the high shear stress compounding action during or before the conventional shear stress extruding action. At S230, the base polymer resin and at least any stabilizing additives are compounded using very high shear stress as previously described. The resulting compounded/refined resin material may then be formed into pellets or other transportable form at S240.

In some embodiments of the invention, the high shear stress compounding action may be accomplished as part of a single continuous process line. In such cases, the action S240 may be eliminated because the output of the high shear stress compounding action may be provided directly as input to the conventional shear stress compounding action. At S250, the compounded/refined polymer resin material is fed to a conventional shear stress extruder. The compounded/refined resin material may be mixed with other final product constituents prior to or during the extruder feed procedure. The additional constituents may include other polymer resins that have been refined according to the methods of the invention and/or polymer resins that have not been refined. In the extruder, the final material constituents are collectively melted and subjected to conventional shear stress forces. The melted polymer material may be passed through one or more filters at S260, which are preferably placed as close to the extrusion die as possible to avoid reagglomeration of microgels downstream of the filters. At S270, the polymer material is extruded and cast onto a casting roll. In various embodiments, the polymer material may be cast as a single layer film or may be cast as one layer in a multi-layer film as previously described. Such multi-layer films may be formed with additional layers comprising resins that have undergone a high shear stress refinement process and/or one or more layers that do not comprise any such resins.

The method M200 ends at S295.

It will be understood that the use of the refined resin and the resin refinement methods of the invention are not limited to particular film casting or extrusion processes. They may, for example, be used in conjunction with any cast or blown film process. It will also be understood that the resin refinement methods of the invention (e.g., method M100) may be used prior to or as part of other processes in addition to extrusion/coextrusion processes.

Film products produced using the methods of the invention have dramatically reduced microgel content and enhanced clarity over films produced from the unrefined resin. The methods of the invention can be used, in particular, to provide refined polyolefin resin materials and films formed therefrom. Most particularly, the methods can be used to form refined PE resin material and PE films having previously unattainable microgel size and count levels. PE resin materials and PE films may be provided according to embodiments of the invention that have substantially no gels with a maximum dimension greater than 100 microns. In some variations, PE resin materials and PE films may be provided in which the largest microgels have a maximum dimension in a range of about 10 microns to about 60 microns. In particular embodiments, PE resin materials may be provided that have a maximum dimension in a range of about 10 microns to about 40 microns. PE resin materials and PE films may also be provided according to embodiments of the invention that have a microgel count in a range of 0-0.2 per mm² of microgels having a maximum dimension greater than 10 microns. In some embodiments, PE resin materials and PE films may have a mean microgel count in a range of 0 to 0.1 per mm² of microgels having a maximum dimension in a range of about 10 microns to about 50 microns.

By limiting the size of included microgels in film products, the methods of the invention also allow the production of films that have minimal protrusions. In particular, PE film materials may be provided according to embodiments of the invention in which the film maximum protrusion height above a nominal planar surface is in a range of about 0.0 to about 5.0 microns. In particularly preferred embodiments, a PE film has substantially no protrusions with a height above a nominal planar surface greater than about 1.0 micron.

The PE films produced according to embodiments of the invention typically have a thickness in a range of about 15 microns to about 80 microns. In some desirable embodiments, the PE film may have a thickness in a range of about 20 microns to about 60 microns. In a particularly desirable embodiment, the PE film may have a thickness in a range of about 25 microns to about 40 microns. The PE film materials may be formed using any of the previously described stabilizers and may also comprise, without limitation, polypropylene (PP), ethylene vinyl acetate (EVA), ethylene methyl acrylate EMA), ethylene methacrylic acid (EMMA), ethylene normal butyl acrylate (EnBA), plastomers such as metallocene catalyzed copolymers of butene, pentene, hexene or octene with ethylene, elastomers or block co-polymers such as styrene-butadiene-styrene (SBS), styrene-ethylene-butylene-styrene (SEBS) and styrene-isoprene-styrene (SIS), catalyst neutralizers such as calcium stearate and others, LLDPE produced using other catalysts, and tackifiers. The PE films produced according to the invention may be formed as a single layer or multiple layers with the same or different constituent materials. In some multiple layer embodiments, only a subset number of layers is formed from PE resin that has been refined according to the methods of the invention.

### Inspection Techniques

One effect of the stringent microgel inclusion and surface topography requirements for surface protection films is that standard inspection techniques may not be adequate. The size of microgels that can cause unacceptable protrusions at the film surface are so small that they may not be detected by ordinary methods. For purposes of evaluating the refined resin materials and surface protection films produced using the methods of the invention, new inspection techniques were required. The following paragraphs describe inspection methods used to provide the data described in the examples below.

In general, counting and sizing microgels can be done by both manual and automated methods. The method used may depend on the quality and consistency of the film surface. If the film has a smooth consistent adhesion surface (i.e., the surface that will contact the substrate to be protected), the automated method may be preferred. If, however, the film has a varying or rough surface, the manual method may be preferred to reduce noise in the data.

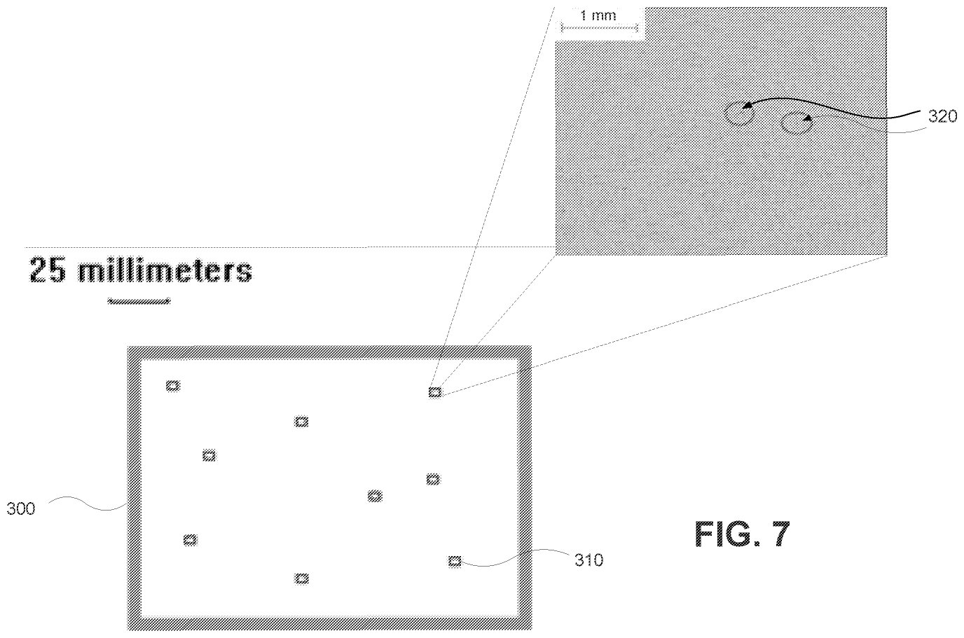

In a manual method, counting microgels requires that framed samples be visually examined under coaxial reflected illumination using a stereomicroscope with 20× zoom magnification. As schematically represented in FIG. 7, a predetermined number of random locations 310 are examined within a framed sample 300 of film material. At each location 310 a rectangular area is magnified to allow identification and counting of microgels at that location. In the illustrated example, the magnified area is 4.68×3.52 mm (16.4736 mm²). The number of microgels 320 in each location can then be recorded and used to provide an estimated count per unit area.

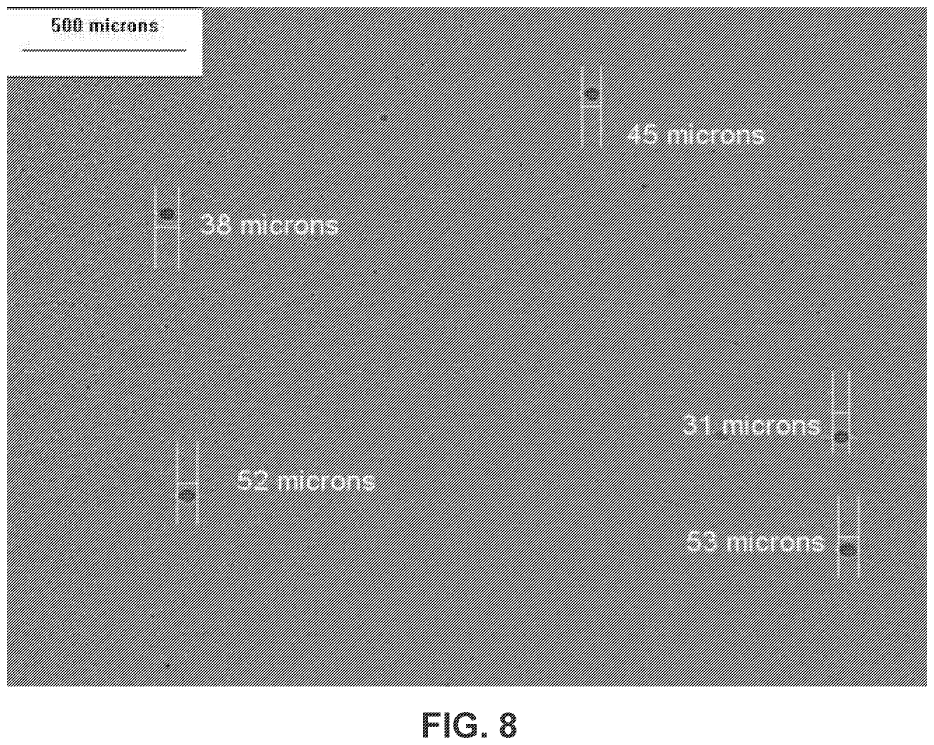

Manual sizing of microgels may be accomplished using imaging software such as Media Cybernetics ImagePro®. ImagePro®, for example, has a “measure” function that can be used to determine the largest dimension of previously identified microgels in a captured image as shown in the screen shot in FIG. 8. These measurements can then be used to determine the frequency of microgels in various size ranges.

For automated counting and sizing, images are captured from framed samples under coaxial reflected illumination using a stereomicroscope with 20× zoom magnification and a digital camera. Magnified images may be captured at a predetermined number of random locations on each frame. Specialized image analysis software is then used to provide count and size information.

The surface topography and, in particular, protrusion height are highly significant for surface protection films. For the examples below, protrusion height above a nominal surface plane was determined using a Zygo NewView7300 Scanning White Light Interferometer with Metropro® software. A specialized application was developed to measure protrusion heights above the average surface plane. This technique allows determination of protrusion heights as small as 0.1 microns.

In addition to microgel and surface topography measurements, film samples are also examined for haze. As used herein, the term haze (also known as wide angle scattering) refers to the percentage of transmitted light passing through a film specimen that deviates by more than 2.5.degree. from the incident beam. For the examples below, haze measurements were accomplished according to ASTM D1003-95. Sampling, sample preparation, equipment, testing parameters, and calculations were all performed within the scope of ASTM D1003-95a.

### EXAMPLES

### Example 1

As a baseline, a multilayer PE film was formed using a conventional shear stress extrusion line similar to that depicted in FIG. 3. The multilayer comprised a core layer, an adhesion layer and a release layer. The core layer was formed from 99.992% low density polyethylene (LDPE) and 0.008% Irganox 1010. The adhesion layer was formed from 75% butene copolymer polyethylene plastomer, 15% high density polyethylene (HDPE) and 10% LDPE. The release layer was formed from 85% LDPE and 15% HDPE. The constituents for each layer were premixed and the three mixtures fed separately into three single screw extruders. In each extruder, the polymer material was subjected to an estimated maximum shear stress of about 66 kPa and passed through multiple filter stages including a final 5-micron melt filter. The filtered melts were extruded through film dies and cast into a single three-layered film on a smooth casting roll. The cooled film was then taken up on a winder. Samples of the film were taken and inspected using the techniques described above to determine microgel size and count information.

### Example 2

A refined multilayer PE film was formed using a high shear stress method similar to M200. The multilayer film comprised a core layer, an adhesion layer and a release layer. The core and release layers were both formed from 59.4% LDPE, 40% HDPE, 0.48% Irganox® 1076 and 0.12% Irgafos® 168. The adhesion layer was formed from 75% butene copolymer polyethylene plastomer, 15% HDPE, 9.56% LDPE, 0.32% Irganox® 1076 and 0.12% Irgafos® 168.

The constituents for the adhesion layer and the constituents for the core and release layer were separately mixed and processed through a high shear extruder. In each case, the materials were fed into a high shear stress, co-rotating twin screw extruder where they were subjected to an estimated maximum shear stress of about 350 kPa. A nitrogen blanket was provided by injecting nitrogen into the hopper and the barrel of the extruder. A vacuum port near the end of the extruder barrel was used to draw of VOCs. The resulting polymer material was extruded through a die and cut into pellets. The pellets were gathered and packaged and sealed for transport. The packaged pellets were later unsealed, and fed into three single screw extruders, the adhesion layer material being fed into one extruder and the core/release layer material being fed into two extruders. In each extruder, the polymer material was subjected to an estimated maximum shear stress of about 50 kPa and passed through multiple filter stages including a final 5-micron melt filter. The filtered melts were extruded through film dies and cast into a single three-layered film on a smooth casting roll. The cooled film was then taken up on a winder. Samples of the film were taken and inspected using the techniques described above to determine microgel size, protrusion and count information.

### Example 3

Another refined multilayer PE film was formed using a high shear stress method similar to M200. This multilayer film comprised a core layer, an adhesion layer and a release layer. The core and release layers were both formed from 59.85% LDPE, 40% HDPE, 0.06% Irganox® 1076 and 0.09% Sandostab P-EPQ. The adhesion layer was formed from 54.85% butene copolymer polyethylene plastomer, 30% HDPE, 15% ethylene octene elastomer, 0.09% Irganox® 1076 and 0.09% Sandostab P-EPQ.

As in Example 2, the constituents for the adhesion layer and the constituents for the core and release layer were separately mixed and processed through a high shear extruder. In each case, the materials were subjected to an estimated maximum shear stress of about 350 kPa, extruded and cut into pellets. As before, the pellets were fed into three extruders and coextruded to form the three layer film. In each extruder, the polymer material was subjected to an estimated maximum shear stress of about 50 kPa. Prior to extrusion, the materials were passed through multiple filter stages including, in this case, a final 7.5-micron melt filter. Samples of the resulting film were taken and inspected using the techniques described above to determine microgel size and protrusion information.

Table III summarizes the microgel content and protrusion height data for each of the three examples. In each case, the data were taken from at least ten film samples, each of which were examined as described above. It can be seen that the two PE film materials formed using the high shear stress refinement methodology of the invention exhibited significantly smaller microgels than the conventionally formed PE material. Further, the refined PE resin film materials exhibited no protrusions greater than 1.0 micron, with the Example 3 film exhibiting no protrusions over 0.2 microns.

TABLE III

| | Max. | Mean | Mean | Max. | |
|---|---|---|---|---|---|
| Polymer Film | Microgel Size | Microgel Size | Microgel Count* | Protrusion | Haze |
| Material | (μm) | (μm) | (no. per mm²) | (μm) | (%) |
| Example 1 | 100-140 | 50-60 | 0.4-0.7 | 1.5-3.0 | 15-20 |
| Standard PE Film | | | | | |
| Example 2 | 30-50 | 20-30 | 0.01-0.04 | 0.5-0.9 | 4-6 |
| Refined PE Film | | | | | |
| Example 3 | 30-50 | 16-26 | — | 0.1-0.2 | 5.8-6.2 |
| Refined PE Film | | | | | |

*Microgels having a largest dimension >10 μm

In addition to the reduction in size and number of microgels, the refined PE film materials also exhibited the unexpected result of a large reduction in haze. The improvement in clarity of the film material is greater than would be expected merely from the visually measurable reduction in microgels. This suggests a very high degree of homogeneity in the film material.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

While the foregoing illustrates and describes exemplary embodiments of this invention, it is to be understood that the invention is not limited to the construction disclosed herein. The invention can be embodied in other specific forms without departing from the spirit or essential attributes.

What is claimed is:

1. A method of forming a thermoplastic polymer film, the method comprising:
melting and subjecting a polymer resin material to shear stresses in a range of 250 kPa to 400 kPa to form a refined resin material, and
forming the thermoplastic polymer film from the refined resin material,
wherein the film is substantially free of microgels having a largest dimension greater than 50 microns, the film has a thickness in a range of 15 micron to 80 microns, and the film has a microgel count in a range of 0 to 0.2 per mm² of microgels having the maximum dimension greater than 10 microns.

2. The method according to claim 1 wherein the polymer resin material consists primarily of one or more polyolefins.

3. The method according to claim 1 wherein the polymer resin material consists primarily of polyethylene.

4. The method according to claim 1 further comprising:
mixing the polymer resin material with one or more antioxidants.

5. The method according to claim 1 wherein the polymer resin material is subjected to shear stresses in a range of 300 kPa to 375 kPa to form the refined resin material.

6. The method according to claim 1 further comprising:
extruding and solidifying the refined resin material.

7. The method according to claim 1 wherein the polymer resin material comprises at least a majority by weight of polyethylene, the method further comprising:
mixing the polymer resin material with one or more antioxidants; and
extruding and solidifying the refined resin material.

8. A method of forming a polymer film, the method comprising:
providing a polymer resin material consisting primarily of polyethylene;
mixing the polymer resin material with one or more antioxidants to form a resin material mixture;
melting and subjecting the resin material mixture to shear stresses in a range of 250 kPa to 400 kPa to form a refined resin material, and
extruding the refined resin material to form the polymer film,
wherein the polymer film is substantially free of microgels having a largest dimension greater than 50 microns, the polymer film has a thickness in a range of 15 micron to 80 microns, and the polymer film has a microgel count in a range of 0 to 0.2 per mm² of microgels having the maximum dimension greater than 10 microns

9. The method according to claim 8, further comprising:
prior to the action of extruding the refined resin material to form the polymer film, extruding and solidifying the refined resin material, and
melting and subjecting the extruded and solidified refined resin material to shear stresses less than 70 kPa.

11. The method according to claim 9, wherein the extruded and solidified refined resin material is in the form of extruded pellets.

12. The method according to claim 8, wherein the resin material mixture is subjected to shear stresses in a range of 300 kPa to 375 kPa to form the refined resin material.
